(19) United States
(12) Patent Application Publication
(10) Pub. No.: US 2026/0249503 A1
(43) Pub. Date: Aug. 27, 2026

(54) DUST SEPARATOR FOR BLIND CUTTING SYSTEMS

(71) Applicant: Home Depot Product Authority, LLC, Atlanta, GA (US)

(72) Inventor: Scott L. Hager, Atlanta, GA (US)

(21) Appl. No.: 19/552,983

(22) Filed: Feb. 27, 2026

Related U.S. Application Data
(60) Provisional application No. 63/764,212, filed on Feb. 27, 2025.

(51) Int. Cl. B26D 7/18; B26D 7/00

(52) U.S. Cl. CPC B26D 7/1863; B26D 2007/0018

(57) ABSTRACT

A cutting assembly for cutting blinds and shades can include a housing defining a chamber, a dust source, at least one component, and a member dividing the chamber into a first and second chamber. The dust source can be located in the first chamber and configured to generate dust from cutting the object. The at least one component can be located in the second chamber. The member can include a first aperture extending therethrough and defining a first fluid pathway placing the first chamber in fluid communication with the second chamber. The member can include a brush located at the first aperture to prevent dust in the first chamber from entering the second chamber. The member can further include at least one gasket located at an opening between the member and at least one other component to prevent dust from entering the second chamber through the opening.

### CROSS-REFERENCE TO RELATED APPLICATION

This application claims the benefit of priority to U.S. application No. 63/764,212, filed on Feb. 27, 2025, which is hereby incorporated by reference in its entirety.

### FIELD

This disclosure relates generally to blind cutting systems. More particularly, this disclosure relates to a dust separator for blind cutting systems.

### BACKGROUND

Window blinds and shades come in a variety of different materials and sizes. The windows upon which the window blinds and shades are being installed also come in a variety of sizes. As a result, window blinds and shades can be cut to a particular length to be customized to fit a corresponding window.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a non-limiting example of a blind cutting machine, according to some embodiments.

FIG. 2 shows a non-limiting example of a blind cutting machine, according to some embodiments.

FIG. 3A shows a first perspective view of the cutting assembly of FIG. 2, according to some embodiments.

FIG. 3B shows a second perspective view of the cutting assembly of FIG. 2, according to some embodiments.

FIG. 4 shows a first perspective view of the first chamber of the cutting assembly of FIG. 2, according to some embodiments.

FIG. 5 shows a second perspective view of the first chamber of the cutting assembly of FIG. 2, according to some embodiments.

FIG. 6 shows a first perspective view of the second chamber of the cutting assembly of FIG. 2, according to some embodiments.

FIG. 7 shows a second perspective view of the second chamber of the cutting assembly of FIG. 2, according to some embodiments.

FIG. 8 is a perspective view of an end stop, according to some embodiments.

FIG. 9 is a rear perspective view of a housing including the cutting assembly of FIG. 2, according to some embodiments.

Like reference numbers represent the same or similar parts throughout.

### DETAILED DESCRIPTION

Window blinds and shades come in a variety of different materials and sizes. For example, window blinds and shades can include cellular window blinds having a plurality of honeycomb cells, faux wood blinds, or roller shades. The windows upon which the window blinds and shades are being installed also come in a variety of sizes. As a result, window blinds and shades may need to be cut to a particular length to be customized to fit a corresponding window.

Embodiments of this disclosure relate to a dust separation member for a window blind and shade cutting machine that is configured to be located within a retail store so that window blinds and shades can be customized to fit a customer's need within the store. In some embodiments, this can avoid a waiting process in which customer's otherwise order window blinds and shades online and wait for them to be cut and shipped to the customer or a retail store for pickup.

More specifically, embodiments of this disclosure relate to improved dust separation and mitigation features for a window blind and shade cutting machine by providing a dust separation member that can divide an inside chamber of a housing of the cutting machine into different chambers, thereby providing a barrier separating one or more components of the cutting machine from a dust source. In some embodiments, the dust separation member allows the one or more components to be located in a different chamber from a chamber including the cutting assembly so as to mitigate contaminating these critical components with dust and debris produced as a result of the cutting process. For example, the critical components can include, but is not limited to, actuators, bearing systems, sensors, gears, power supplies, other components where the component's performance can be affected by being exposed to dust, or any combinations thereof.

In some embodiments, the dust separation member can include an aperture extending through the dust separation member so as to place one side in fluid communication with the other side of the dust separation member. In this regard, the aperture can allow make-up air to pass from one side to the other side of the dust separation member, as will be further described herein.

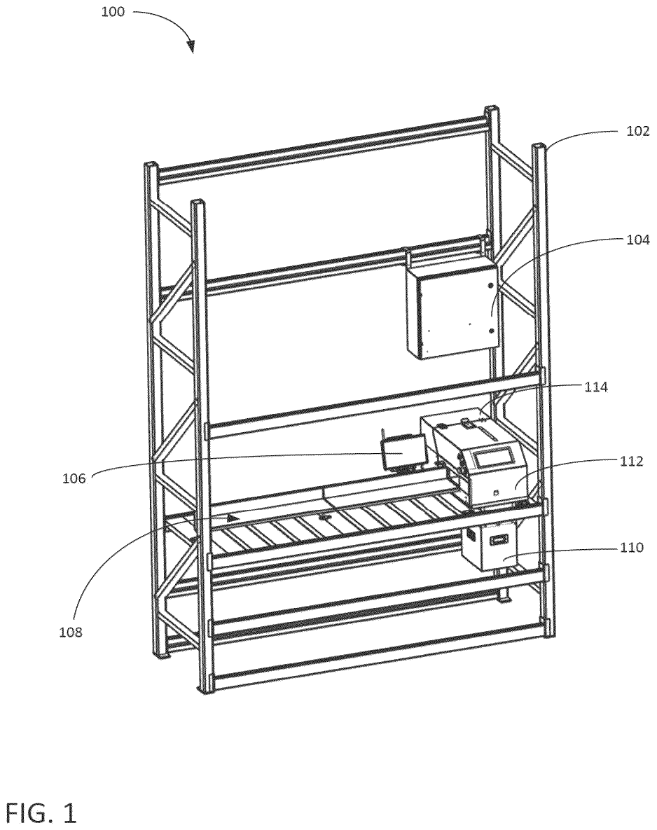

FIG. 1 shows a non-limiting example of a blind cutting machine 100, according to some embodiments. The blind cutting machine 100 can also be referred to herein as a blind and shade cutting machine. The blind cutting machine 100 can include a support structure 102. In the illustrated embodiment, the support structure 102 is a frame. It is to be appreciated that the configuration of the support structure 102 can vary beyond the illustrated embodiment. The blind cutting machine 100 can include an electronics module 104, a display screen 106, a platform 108, a cutting assembly 112, and a waste bin 110. It is to be appreciated that the blind cutting machine 100 can include one or more of these components. For example, the blind cutting machine 100 can include electronics module 104, platform 108, and cutting assembly 112. In another example, the blind cutting machine 100 can include electronics module 104, platform 108, cutting assembly 112, and waste bin 110. In other examples, the blind cutting machine 100 can include platform 108, cutting assembly 112, and waste bin 110, and the cutting assembly 112 can include the electronics module 104 therein. It is to be appreciated that the blind cutting machine 100 can include one or more additional components.

In some embodiments, the electronics module 104 can include various circuitry to connect the blind cutting machine 100 to a power source. In some embodiments, the electronics module 104 can include various electrical components to connect the blind cutting machine 100 to a power source.

In some embodiments, the display screen 106 can provide a user interface for an operator to interact with the blind cutting machine 100 and provide for particular settings related to the blind material, length, combinations thereof, or the like.

In some embodiments, the platform 108 can receive a window blind or shade to be cut. In some embodiments, the platform 108 can be utilized to facilitate the operator positioning the window blind or shade into position to be cut by the cutting assembly 112.

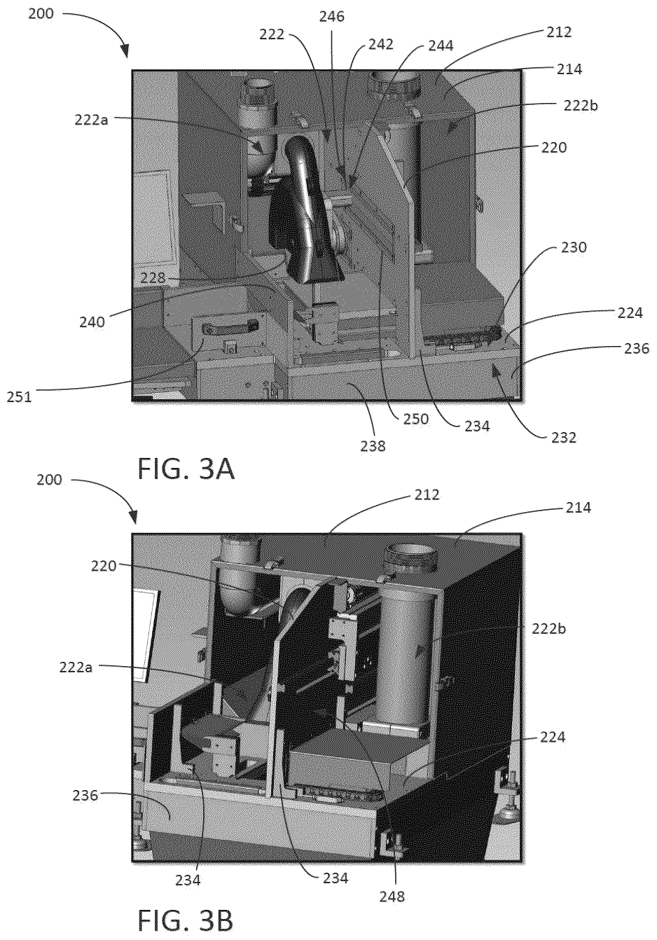

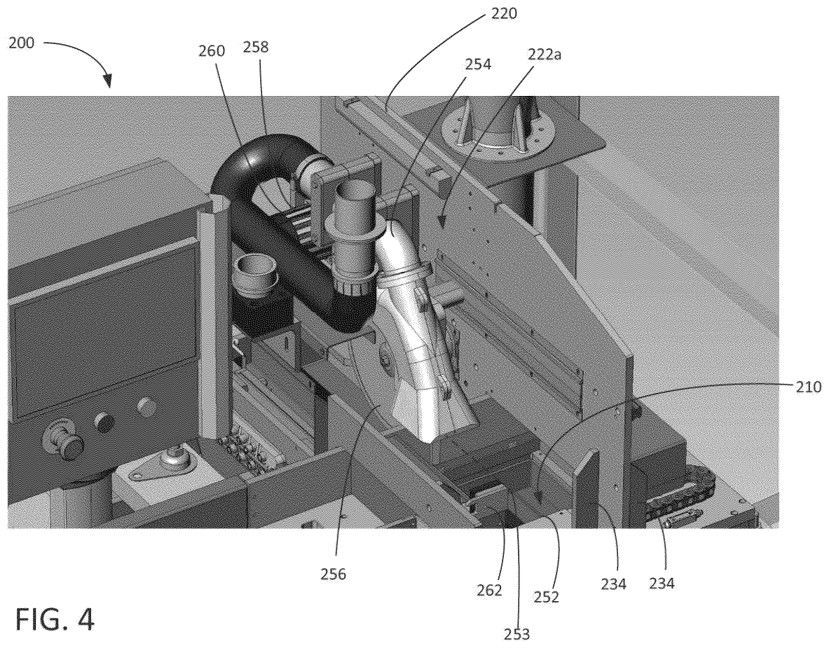

In some embodiments, the cutting assembly 112 can include a housing 114 within which a cutting blade (not shown) and other components are enclosed, thereby protecting the operator from any interaction with the cutting blade itself. In some embodiments, the cutting assembly can include a blade shroud covering a portion of a cutting blade (see FIGS. 3A, 3B, and 4 below). In some embodiments, the blade shroud can be fluidly connected to a dust removal system (e.g., a vacuum or the like).

In some embodiments, the blind cutting machine 100 includes the waste bin 110 for collecting waste from the cutting process.

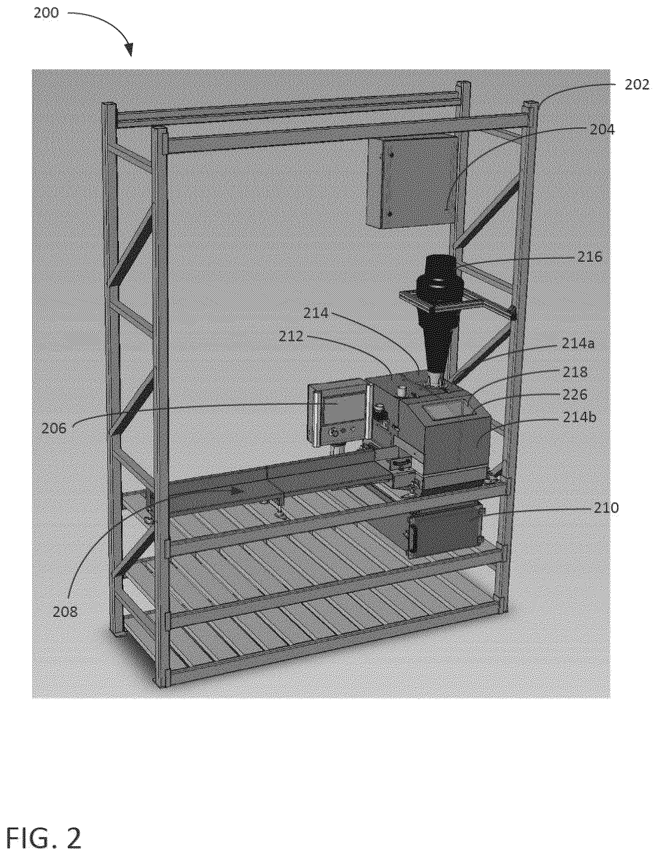

FIG. 2 shows a non-limiting example of a blind cutting machine 200, according to some embodiments. The blind cutting machine 200 can include a support structure 202. In the illustrated embodiment, the support structure 202 is a frame. It is to be appreciated that the configuration of the support structure 202 can vary beyond the illustrated embodiment. The blind cutting machine 200 can include an electronics module 204, a display screen 206, a platform 208, a cutting assembly 212, a waste bin 210, and a dust removal system 216. It is to be appreciated that the blind cutting machine 200 can include one or more of these components. It is to be appreciated that the blind cutting machine 200 can include one or more additional components. It is to be appreciated that a blind cutting machine can include one or more components from blind cutting machine 100 and blind cutting machine 200, or the blind cutting machine can include one or more additional components.

In some embodiments, the electronics module 204 can include various circuitry to connect the blind cutting machine 200 to a power source. In some embodiments, the electronics module 204 can include various electrical components to connect the blind cutting machine 200 to a power source.

In some embodiments, the display screen 206 can provide a user interface for an operator to interact with the blind cutting machine 200 and provide for particular settings related to the blind material, length, combinations thereof, or the like.

In some embodiments, the platform 208 can receive a window blind or shade to be cut. In some embodiments, the platform 208 can be utilized to facilitate the operator positioning the window blind or shade into position to be cut by the cutting assembly 212.

In some embodiments, the cutting assembly 212 can include a housing 214 within which a cutting blade (not shown) and other components are enclosed, thereby protecting the operator from any interaction with the cutting blade itself. In some embodiments, a handle or other movable clamping feature can be disposed outside the housing via which an operator can clamp the window blind or shade to be held in place during the cutting operation.

In some embodiments, the cutting assembly can include a blade shroud covering a portion of a cutting blade (see FIGS. 3A, 3B, and 4 below). In some embodiments, the housing 214 can include a viewing port 218 extending through the housing 214, the viewing port 218 allowing the operator to view into the cutting assembly 212 during the cutting or when the cutting process is stopped such as to observe the cutting of the blind or shade or to troubleshoot any issues (e.g., jammed material, etc.). For example, the housing 214 can include an aperture 226 defining the viewing port 218 extending through a side of housing 214 defining the viewing port 218 that is then covered by a transparent material to allow the operator to view into the cutting assembly 212 while simultaneously protecting the operator from accessing the components in the cutting assembly 212.

In some embodiments, the housing 214 can include a first housing member 214a and a second housing member 214b. In some embodiments, the viewing port 218 can be located on the first housing member 214a. In other embodiments, the viewing port 218 can be located on the second housing member 214b.

In some embodiments, the first housing member 214a can be attached to a frame of the cutting assembly 212. In some embodiments, the frame of the cutting assembly 212 can be a base, and the first housing member 214a can be attached to the base. In some embodiments, the housing 214 can be attached to the first housing member 214a and the frame.

In some embodiments, the second housing member 214b can be attached to the first housing member 214a using one or more fasteners to restrict an operator from accessing components located in the cutting assembly 212 such as, for example, the cutting blade or saw. In other embodiments, the second housing member 214b can be attached to the first housing member 214a by one or more hinges to allow the second housing member 214b to be pivotably displaced relative the first housing member 214a so as to allow the operator to access the inside of the cutting assembly 212. It is to be appreciated that the first housing member 214a can be attached to the second housing member 214b using one or more components including the fasteners and the hinges, or they can be attached to each other using additional components. It is also to be appreciated that the fasteners can include, but is not limited to, screws, nuts, bolts, clasps, clips, brackets, rivets, clamps, locks, hooks, latches, retention features, other fasteners, or any combinations thereof.

In some embodiments, the blind cutting machine 200 includes the waste bin 210 for collecting waste from the cutting process.

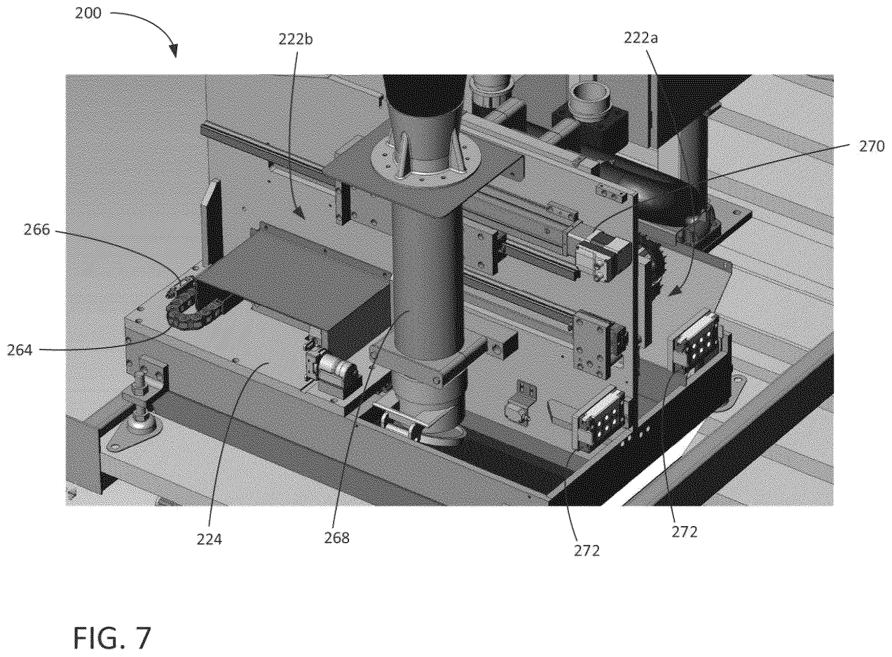

In some embodiments, the blind cutting machine 200 includes the dust removal system 216 for removing dust and debris produced by the cutting assembly 212 as a result of cutting the blind or shade. In some embodiments, the dust removal system 216 can be attached directly to a top of the cutting assembly 212 so as to reduce an overall machine footprint. In some embodiments, the dust removal system 216 can be attached to the top of the cutting assembly 212 so as to ensure an airtight seal between the dust removal system 216 and the dust collection container 268 (FIG. 7). In some embodiments, the dust removal system 216 can be attached to a top of the housing 214. It is to be appreciated that the configuration and arrangement of the dust removal system 216 in the blind cutting machine 100 is exemplary and not intended to be limiting and the dust removal system 216 can include different configurations including the configuration shown in FIG. 2. In some embodiments, the dust removal system 216 can be located adjacent to or otherwise next to or near the blind cutting machine 200 and fluidly connected by a conduit such as, but not limited to, a hose or the like, attached to cutting assembly 212, housing 214, or a combination of cutting assembly 212 and housing 214.

FIG. 3A shows a first perspective view of the cutting assembly 212 of FIG. 2, according to some embodiments. FIG. 3B shows a second perspective view of the cutting assembly 212 of FIG. 2, according to some embodiments. Unless specifically referenced, FIGS. 3A and 3B will be described collectively.

The cutting assembly 212 includes a dust separation member 220. The dust separation member 220 can have appropriate dimensions so as to divide chamber 222, the chamber 222 being defined by housing 214. The dust separation member 220 divides the chamber 222 into different chambers to allow one or more components of the cutting assembly 212 to be located in a different chamber from the chamber of the dust source 228 to mitigate exposure of the one or more components to dust produced as a result of cutting operations on the blinds and shades.

In some embodiments, the dust separation member 220 can divide the chamber 222 into a first chamber 222a and a second chamber 222b. In other embodiments, the dust separation member 220 can divide the chamber 222 of housing 214 into at least a first chamber 222a and a second chamber 222b. For example, the dust separation member 220 can divide the housing 214 into more than two chambers. In another example, the dust separation member 220 can divide the housing 214 into three or more chambers. In some embodiments, the dust separation member 220 can be a planar member that extends along a plane and divides the chamber 222 of the cutting assembly 212 into the first chamber 222a and the second chamber 222b.

The cutting assembly 212 can include a base member 224 defining a bottom surface of chamber 222, the base member 224 having a first side 230 and a second side 232 opposite the first side 230. In some embodiments, the base member 224 can include a top surface located on the first side 230, the top surface defining the bottom surface of chamber 222. In some embodiments, the dust separation member 220 can be arranged at the first side 230 on the top surface of base member 224. In some embodiments, the dust separation member 220 can be arranged on the top surface of base member 224 such that a plane of the dust separation member 220 is perpendicular to a plane of the base member 224. In some embodiments, the plane of the dust separation member 220 can be substantially perpendicular to the plane of the base member 224.

In some embodiments, the housing 214 can include base member 224. In other embodiments, the cutting assembly 212 can include a base assembly 236, the base assembly 236 including base member 224 and at least one sidewall 238. In some embodiments, the at least one sidewall 238 can be located at the second side 232 of the base member 224. It is to be appreciated that the base assembly 236 can include one or more other components to form the base assembly 236 and to house one or more components of the cutting assembly 212 such as, for example, portions of the actuator and bearing assembly for translating the carrier.

In some embodiments, the cutting assembly 212 can include a bracket member 234. The bracket member 234 can couple the dust separation member 220 to a frame of the cutting assembly 212. In some embodiments, the bracket member 234 can couple the dust separation member 220 to the base member 224. In some embodiments, the bracket member 234 can fixedly couple the dust separation member 220 to the base member 224 using one or more fasteners. In some embodiments, the one or more fasteners can include, but is not limited to, screws, nuts, bolts, rivets, welds, epoxy, adhesives, clamps, clips, solder, other types of fasteners, or any combinations thereof. In some embodiments, the cutting assembly 212 can include one or more bracket member 234. In some embodiments, each of the bracket member 234 can be located in the first chamber 222a, second chamber 222b, or both. In some embodiments, the bracket member 234 can be an L-shaped bracket member including a first arm having a first length and a second arm having a second length. In some embodiments, the first length can be longer length than the second length. In some embodiments, the first arm of the bracket member 234 can be coupled to a component of the cutting assembly 212 and the second arm of the bracket member 234 can be coupled to the base member 224. In some embodiments, the dust separation member 220 can be coupled to the first arm of the bracket member 234.

In some embodiments, the cutting assembly 212 includes one or more sidewalls 240. The one or more sidewalls may be located on the first side 230 of the base member 224. In some embodiments, the cutting assembly 212 may include one or more bracket members 234 that can couple the one or more sidewalls 240 to the base member 224 using one or more fasteners. In addition, in some embodiments, the housing 214 can have appropriate dimensions corresponding to the one or more sidewalls 240 so as to form the chamber 222. In some embodiments, the one or more sidewalls 240 can be coupled to the first arm of the bracket member 234 and the base member 224 can be coupled to the second arm of the bracket member 234.

In some embodiments, the base member 224 can include an alignment guide for positioning the dust separation member 220 onto the base member 224. In some embodiments, the alignment guide can include, but is not limited to, a slot, groove, channel, recess, step, other like features, or any combination thereof, for aligning the dust separation member 220 relative the base member 224 and so as to facilitate forming the first chamber 222a and the second chamber 222b in the cutting assembly 212.

In some embodiments, the dust separation member 220 includes an aperture 244 (e.g., first aperture) extending from a first side 246 of the dust separation member 220 to a second side 248 of the dust separation member 220. In some embodiments, the aperture 244 defines a fluid pathway placing the first chamber 222a in fluid communication with the second chamber 222b.

In some embodiments, the cutting assembly 212 further includes a brush 242 located at the aperture 244, the brush 242 being configured to prevent dust and debris or other materials located in the first chamber 222a from entering the second chamber 222b through the aperture 244 (or vice versa). In some embodiments, the brush 242 can be installed into the aperture 244 of the dust separation member 220. In other embodiments, the brush 242 can be attached to the dust separation member 220 at the aperture 244. For example, the brush 242 can be attached to the dust separation member 220 using one or more fasteners.

In some embodiments, the cutting assembly 212 includes at least one gasket 250, the at least one gasket 250 being configured to seal a corresponding opening located between the dust separation member 220 and another component of the cutting assembly 212 to prevent dust from entering the second chamber 222b from the first chamber 222a through the opening. For example, the at least one gasket 250 may be installed between the dust separation member 220 and the base member 224 at a bottom of the dust separation member 220 to seal any openings between the dust separation member 220 and the base member 224 and to prevent any dust or debris from moving from the first chamber 222a to the second chamber 222b.

In the cutting assembly 212, brushes 242 and gaskets 250 can be used in corresponding areas to prevent dust from moving from the first chamber 222a (e.g., dirty side) over to the second chamber 222b (e.g., clean side). In some embodiments, the cutting assembly 212 may utilize a dust removal system 216 including a vacuum to generate a vacuum force in the first chamber 222a to draw in at least some of the dust and debris that may be generated in the first chamber 222a as a result of the cutting operations. The aperture 244 allows for providing the first chamber 222a with “make-up air” from the second chamber 222b. As used herein, the term “make-up air” refers to air that is provided to neutralize the pressure inside of the respective chamber and is drawn into the chamber via a path of least resistance.

In some embodiments, these “paths” have been utilized to work as an advantage to the cutting assembly 212. The paths can reduce and/or eliminate dust ingress in critical areas that need to remain clean for reliability of the blind cutting machine 200. For example, when the vacuum is turned on, clean make-up air is drawn into the first chamber 222a through the path defined by the aperture 244 from the second chamber 222b. This configuration also prevents dirty air from traveling back into the clean side of second chamber 222b through the aperture 244. The brush 242 can be configured to aid in preventing the dust and debris in the dirty air from traveling back into the second chamber 222b from the first chamber 222a. Additionally, in some embodiments, when the vacuum is turned on, clean outside air can be drawn into the first chamber 222a through a blind entrance gate to prevent dirty air from being pushed out of the machine and to the operator, as will be further described herein. In some embodiments, the blind cutting machine 200 includes an external clamp 251. In some embodiments, the external clamp 251 can be manipulated by an operator of the blind cutting machine 200 to hold the window shade or blind that is being cut. The external clamp 251 can serve to provide additional force for holding the window shade or blind in place while being cut in addition to an internal clamp (described in further detail below) within the housing 214.

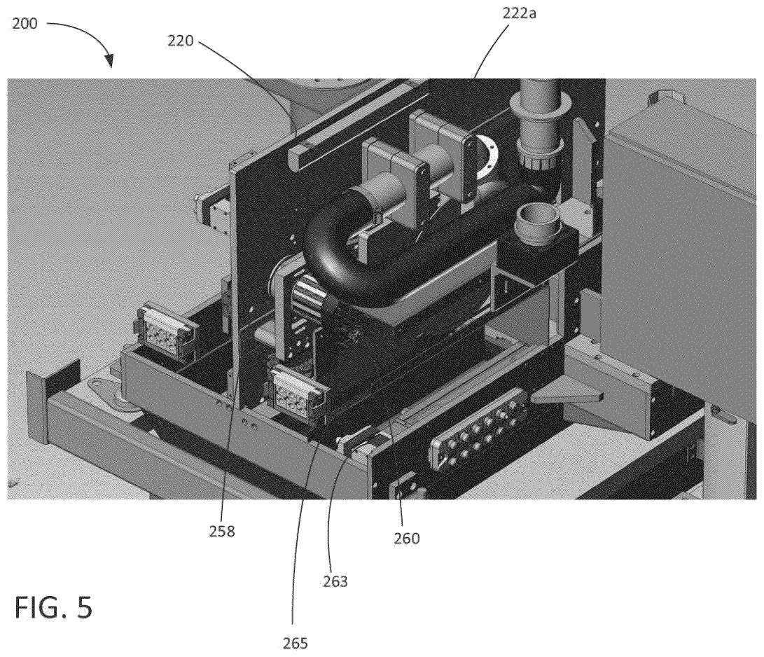

FIG. 4 is a first perspective view of the first chamber 222a of the cutting assembly 212 of FIG. 2 with the housing 214 removed, according to some embodiments. FIG. 5 is a second perspective view of the first chamber 222a of the cutting assembly 212 of FIG. 2 with the housing 214 removed, according to some embodiments. Unless specifically referenced, FIGS. 4 and 5 will be described collectively.

In some embodiments, the base member 224 may include an aperture 252 located at the first chamber 222a defining an opening to waste bin 210 (FIG. 2). That is, the first chamber 222a can include an open bottom defined by the aperture 252 to allow waste products from the cutting process to drop down into the waste bin 210.

In some embodiments, the cutting assembly 212 can include a blade shroud 254 located in the first chamber 222a. In some embodiments, the cutting assembly 212 can include a cutting blade 256 located in the first chamber 222a. In some embodiments, the blade shroud 254 may be located around a periphery of the cutting blade 256 in the first chamber 222a. In other embodiments, the blade shroud 254 may be located around a portion of a periphery of the cutting blade 256. In some embodiments, the blade shroud 254 can be in fluid communication with the dust removal system 216. In other embodiments, the blade shroud 254 can be in fluid communication with the vacuum of the dust removal system 216 so that dust and debris generated during the cutting process can be drawn into the dust removal system 216 through the blade shroud 254.

In some embodiments, the dust removal system 216 can be fluidly connected to the blade shroud 254 that covers at least a portion of the cutting blade 256 so as to remove dust produced as a result of the cutting operation from inside the first chamber 222a of the housing 214 of cutting assembly 212.

In some embodiments, the cutting blade 256 can be a circular cutting blade configured to rotate about an axis, an outer circumference of the cutting blade 256 having one or more teeth for cutting into an object such as, for example, a window blind or shade. In other embodiments, the cutting blade 256 can be a reciprocating cutting blade configured to move rapidly between first and second positions to cut through the object. It is to be appreciated that the cutting blade 256 can include the circular cutting blade, the reciprocating cutting blade, or other types of cutting blades for cutting through the object.

In some embodiments, the cutting assembly 212 can include a drive assembly 258 located in the first chamber 222a. In some embodiments, the drive assembly 258 can be connected to a motor 260 located in the first chamber 222a. The motor 260 can be coupled to the cutting blade 256 through the drive assembly 258, the motor 260 being configured to provide the driving force for causing the rotation of the cutting blade 256 for cutting the objects. In some embodiments, the motor 260 can generally be sealed to prevent ingress of dust or debris generated during the cutting process. As a result, the motor 260 can be located in the first chamber 222a.

In some embodiments, the cutting assembly 212 can include an internal clamp 262 located in the first chamber 222a. In some embodiments, the internal clamp 262 and the external clamp 251 (FIG. 3A, FIG. 3B) are configured to clamp onto the object inserted into the first chamber 222a of the cutting assembly 212 prior to the cutting to prevent movement of the object. The external clamp 251 is mechanically connected to the internal clamp 262 and to an actuator 263 for moving the internal clamp 262. In some embodiments, the internal clamp 262 and the external clamp 251 clamping onto the object near the cutting blade 256 can reduce vibrations of the object during the cutting, thereby improving the consistency of the cutting operation and reducing an amount of dust produced during the cutting. In some embodiments, the actuator 263 is configured to translate the external clamp 251 and the internal clamp 262 prior to beginning and after completing a cutting cycle. The pressure applied through the actuator 263 and the external clamp 251 and internal clamp 262 serves to hold the window shade or blind in place during the cutting operation and releases once the cutting operation is completed.

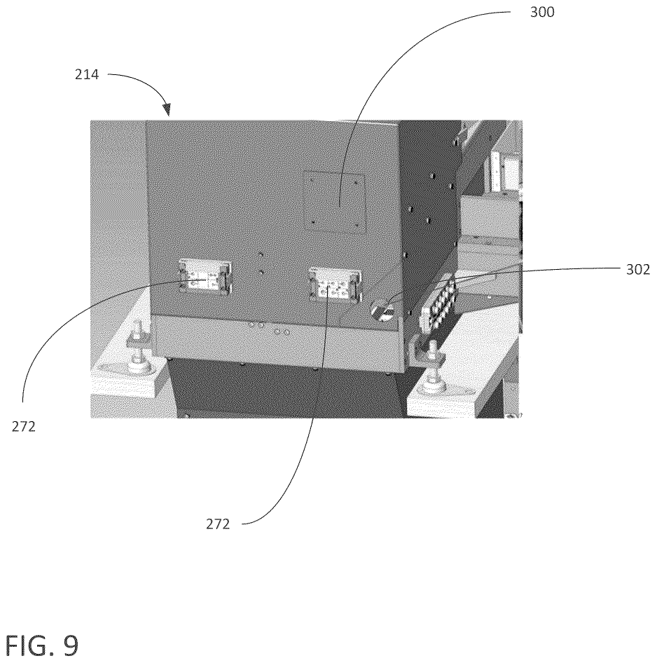

To prevent contaminants such as dust and debris from contacting the actuator 263, a cover 265 is disposed within the first chamber 222a separating the actuator 263 from the dust source 228. The cover 265 is shown from a different view in FIG. 9 as well. In some embodiments, even though the actuator 263 is placed within the first chamber 222a, the inclusion of the cover 265 provides separation for the actuator 263 from the dust source 228.

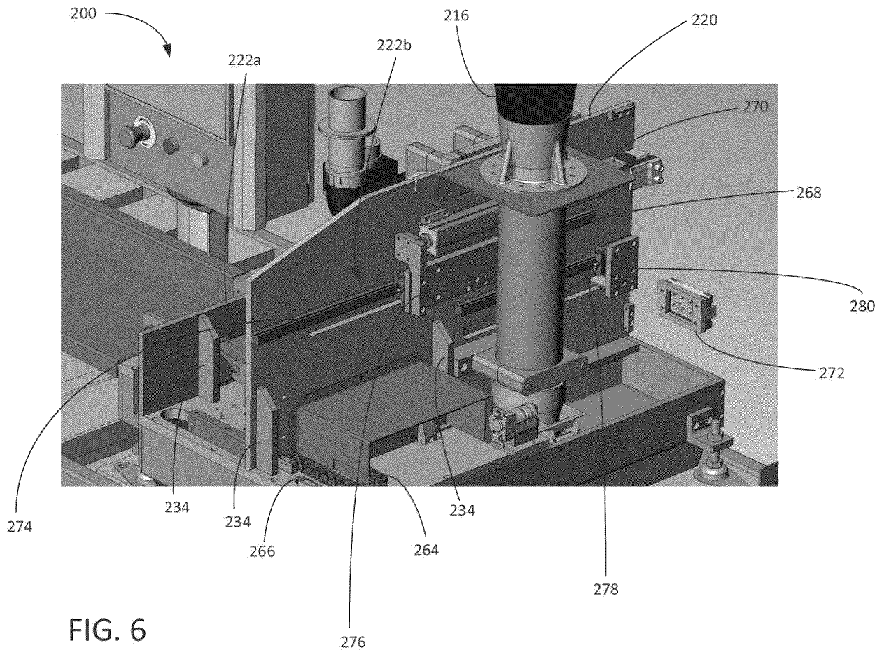

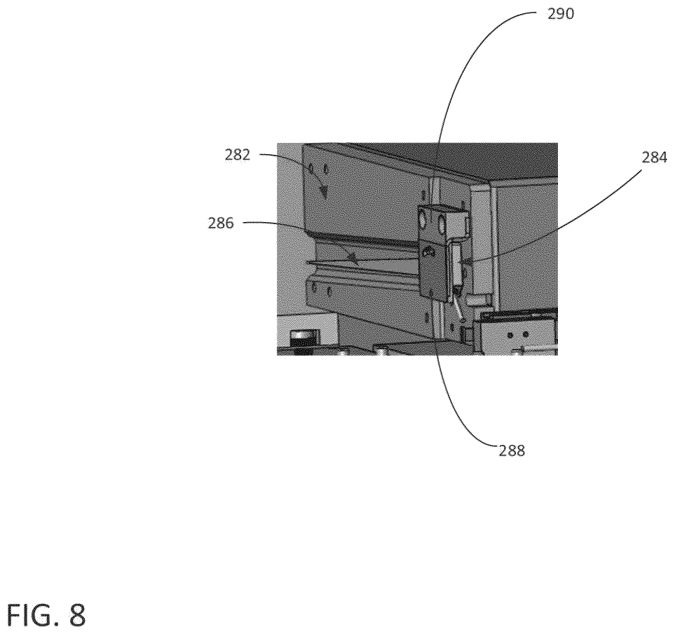

FIG. 6 is a first perspective view of the second chamber 222b of the cutting assembly 212 of FIG. 2 with the housing 214 removed, according to some embodiments. FIG. 7 is a second perspective view of the second chamber 222b of the cutting assembly 212 of FIG. 2 with the housing 214 removed, according to some embodiments. FIG. 8 is a perspective view of an end stop 282, according to some embodiments. Unless specifically referenced, FIGS. 6-8 will be described collectively.

In some embodiments, the cutting assembly 212 can include one or more components in the second chamber 222b. In some embodiments, the second chamber 222b can include the one or more components of the cutting assembly 212 to prevent contaminating the components with dust and debris from the first chamber 222a. In some embodiments, the cutting assembly 212 can include one or more components in the second chamber 222b including, for example, wire guide 264 and a laser controller 266, among other components. In some embodiments, the laser controller 266 can be used to control a laser 284 that is used to detect whether the end stop 282 that abuts the window shade or blind being cut and locates the window shade or blind in the appropriate position to cut to the desired length. In some embodiments, the laser 284 is connected to the end stop 282 via a bracket 288 and mount 290. The laser 284 can emit a laser beam 286 that is disrupted when the window shade or blind is in the appropriate location so the laser 284 can detect whether a window shade or blind is inserted into the housing 214. If no blind is detected, the laser controller 266 can instruct the blind cutting machine 200 to prevent the cutting operation. In some embodiments, when a window shade or blind is detected, the laser controller 266 will indicate that a window shade or blind has been detected and allow the cutting process to be initiated.

In some embodiments, the cutting assembly 212 can include a dust collection container 268. The dust collection container 268 is used to accumulate dust, contain it throughout the day, and automatically dump it once a certain amount has been accumulated. The dust collection container 268 can also be referred to herein as a dust collection canister. In some embodiments, the dumping mechanism can be activated by an actuator or other mechanical assembly to automatically empty the dust collection container 268. In some embodiments, the dumping mechanism can be activated by an actuator that moves the end stop. In such embodiments, once a defined number of cutting cycles have been completed, the end stop actuator can move beyond its normal operating amount and automatically empty the dust collection container 268. In some embodiments, the end stop actuator can be used to automatically return to the closed position for the dust collection container 268 after emptying. In some embodiments, the dust collection container 268 can have one or more resilient elements such as a spring that cause the container 268 to automatically close after emptying. In some embodiments, the actuator or other mechanical assembly is independent of the actuator that moves the end stop.

In some embodiments, the dust removal system 216 can be installed onto the top of the cutting assembly 212 in connection with the dust collection container 268. In some embodiments, the dust collection container 268 can be in fluid communication with the dust removal system 216. In other embodiments, the dust collection container 268 can also be in fluid communication with the blade shroud 254. In some embodiments, the dust removal system 216 can place the dust collection container 268 in fluid communication with the blade shroud 254 to enable dust in the first chamber 222a to be drawn in through the blade shroud 254 by the vacuum force produced by the dust removal system 216 and to accumulate in the dust collection container 268. In some embodiments, the dust can accumulate in the dust collection container 268 until such a time as the dust is evacuated from the dust collection container 268. In some embodiments, the dust collected in the dust collection container 268 can be received from the blade shroud 254 and deposited into the dust collection container 268 using the dust removal system 216. In other embodiments, the dust collected in the dust collection container 268 can be received from the first chamber 222a using the dust removal system 216 and accumulates therein until the certain amount has been accumulated.

In some embodiments, the blind cutting machine 200 includes one or more actuators 270. In some embodiments, the one or more actuators 270 are configured to translate the cutting blade 256 and associated components (e.g., blade shroud 254) linearly within the first chamber 222a to complete the cutting process. In some embodiments, the one or more actuators 270 are disposed in the second side 248 to protect the components from debris generated during the cutting process.

Referring to FIG. 7, in some embodiments, the cutting assembly 212 can include one or more connectors 272 connected to an outside of the cutting assembly 212. In some embodiments, each connector 272 can include one or more connection points for electrical wiring necessary to operate the blind cutting machine 200.

In some embodiments, the connector 272 can be installed onto a side of the cutting assembly 212 in the chamber 222. In some embodiments, an exterior of the connector 272 facing the chamber 222 can be covered or configured to protect the connector 272 and its components from dust ingress.

As illustrated in FIG. 6, the blind cutting machine 200 can include a member 274, a guide 276, a member 278, and a guide 280. The member 274 and the member 278 can be, for example, a rail or the like. The guide 276 is configured to slidingly engage with the member 274 and the guide 280 is configured to slidingly engage with the member 278. The combination of the guide 276 and the guide 280 can support the cutting components (e.g., cutting blade 256, drive assembly 258, motor 260 so that when the one or more actuators 270 is activated, the cutting components translate linearly to perform the cutting operation. In some embodiments, the guide 276 can be connected to the one or more actuators 270 while the guide 280 may not be connected to the one or more actuators 270. As a result, the guide 280 may serve as a stabilizer.

FIG. 9 is a rear perspective view of the housing 214, according to some embodiments. In the illustrated embodiment, the housing 214 includes a cover 300 secured to the housing 214. In some embodiments, the cover 300 can be made of a same material as the housing 214. In some embodiments, the cover 300 can be included to cover an opening in the housing 214. In some embodiments, the cover 300 can be included to prevent airflow through the opening. In some embodiments, the cover 300 can be removed and a connection to the dust removal system 216 can be added. The additional connection to the dust removal system 216 can provide additional airflow out of the housing 214 to remove dust and debris from the cutting process. In some embodiments, the connection can be made to a dust removal system that is separate (e.g., in addition to or in place of) from dust removal system 216.

In some embodiments, the housing 214 includes an aperture 302. In some embodiments, the aperture 302 can provide a fresh air intake. In some embodiments, the location of the aperture 302 is selected such that the fresh air is allowed to travel into the area of the first chamber 222a that is separated by the cover 265. As a result, in some embodiments, the fresh air is able to pass over the actuator 263.

In some embodiments, an assembly includes a housing defining a chamber, a dust source, at least one component, and a member dividing the chamber into a first chamber and a second chamber. In some embodiments, the dust source is located in the first chamber and the at least one component is located in the second chamber. In some embodiments, the dust source is configured to generate dust as a result of cutting an object.

In some embodiments, the member includes a first aperture extending from a first side of the member to a second side of the member. In some embodiments, the first aperture defines a first fluid pathway placing the first chamber in fluid communication with the second chamber.

In some embodiments, the member further includes a brush located at the first aperture. In some embodiments, the brush is configured to prevent dust located in the first chamber from entering the second chamber through the first aperture.

In some embodiments, the member further includes at least one gasket. In some embodiments, the at least one gasket is configured to seal an opening located between the member and at least one other component of the assembly to prevent dust from entering the second chamber from the first chamber through the opening.

In some embodiments, the housing includes a base member, a first housing member attached to the base member, and a second housing member attached to the first housing member. In some embodiments, a position of the second housing member may be displaced relative the first housing member to allow an operator to access the chamber.

In some embodiments, the dust source includes a cutting blade configured for cutting the object.

In some embodiments, the object includes a window blind or a shade.

In some embodiments, the at least one component includes an actuator, and a container.

In some embodiments, the actuator defines a second fluid pathway for providing make-up air from an outside of the housing to the second chamber.

In some embodiments, the container is configured to accumulate dust produced as a result of cutting the object.

In some embodiments, the housing includes a viewing port extending through the housing.

In some embodiments, a system including a cutting assembly including a housing defining a chamber, a cutting blade, at least one component, and a member dividing the chamber into a first chamber and a second chamber, and a dust removal system including a vacuum in fluid communication with the at least one component. In some embodiments, the cutting blade is located in the first chamber and the at least one component is located in the second chamber. In some embodiments, the cutting blade is configured to generate dust as a result of cutting an object including a window blind or shade.

In some embodiments, the member includes a first aperture extending from a first side of the member to a second side of the member. In some embodiments, the first aperture defines a first fluid pathway placing the first chamber in fluid communication with the second chamber.

In some embodiments, the member further includes a brush located at the first aperture, the brush being configured to prevent dust located in the first chamber from entering the second chamber through the first aperture, and at least one gasket, the at least one gasket being configured to seal an opening located between the member and at least one other component of the cutting assembly to prevent dust from entering the second chamber from the first chamber through the opening.

In some embodiments, the housing includes a base member, a first housing member attached to the base member, and a second housing member attached to the first housing member. In some embodiments, a position of the second housing member is configured to be pivotably displaceable relative the first housing member to allow an operator to access the chamber.

In some embodiments, the at least one component includes a container. In some embodiments, the container accumulates the dust collected from the first chamber.

In some embodiments, the cutting assembly further includes an actuator located in the second chamber. In some embodiments, the actuator defines a second fluid pathway for providing make-up air from an outside of the housing to the second chamber.

In some embodiments, a device includes a housing defining a chamber, a cutting blade, a container, and a member dividing the chamber into a first chamber and a second chamber, the member including a first aperture extending from a first side of the member to a second side of the member, the first aperture defining a first fluid pathway placing the first chamber in fluid communication with the second chamber. In some embodiments, the cutting blade is located in the first chamber, and the cutting blade is configured to generate dust as a result of cutting an object including a window blind or shade. In some embodiments, the container is located in the second chamber and the container accumulates the dust collected from the first chamber by a dust removal system including a vacuum in fluid communication with the container and the first chamber.

In some embodiments, the member further includes a brush located at the first aperture, the brush being configured to prevent dust located in the first chamber from entering the second chamber through the first aperture, and at least one gasket, the at least one gasket being configured to seal an opening located between the member and at least one other component of the device to prevent the dust from entering the second chamber from the first chamber through the opening.

In some embodiments, the device further includes an actuator located in the second chamber. In some embodiments, the actuator defines a second fluid pathway for providing make-up air from an outside of the housing to the second chamber.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments,” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be: disposed directly between both of the two other structural elements such that the particular structural component is in direct contact with both of the two other structural elements; disposed directly next to only one of the two other structural elements such that the particular structural component is in direct contact with only one of the two other structural elements; disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

What is claimed is:

1. An assembly comprising:
a housing defining a chamber;
a dust source;
at least one component; and
a member dividing the chamber into a first chamber and a second chamber;
wherein the dust source is located in the first chamber and the at least one component is located in the second chamber, and
wherein the dust source is configured to generate dust as a result of cutting an object.

2. The assembly of claim 1, wherein the member comprises:
a first aperture extending from a first side of the member to a second side of the member, wherein the first aperture defines a first fluid pathway placing the first chamber in fluid communication with the second chamber.

3. The assembly of claim 2, wherein the member further comprises:
a brush located at the first aperture,
wherein the brush is configured to prevent dust located in the first chamber from entering the second chamber through the first aperture.

4. The assembly of claim 1, wherein the member further comprises:
at least one gasket,
wherein the at least one gasket is configured to seal an opening located between the member and at least one other component of the assembly to prevent dust from entering the second chamber from the first chamber through the opening.

5. The assembly of claim 1, wherein the housing comprises:
a base member;
a first housing member attached to the base member; and
a second housing member attached to the first housing member,
wherein a position of the second housing member may be displaced relative the first housing member to allow an operator to access the chamber.

6. The assembly of claim 1, wherein the dust source comprises a cutting blade configured for cutting the object.

7. The assembly of claim 6, wherein the object includes a window blind or a shade.

8. The assembly of claim 1, wherein the at least one component comprises:
an actuator, and
a container.

9. The assembly of claim 8, wherein the actuator defines a second fluid pathway for providing make-up air from an outside of the housing to the second chamber.

10. The assembly of claim 8, wherein the container is configured to accumulate dust produced as a result of cutting the object.

11. The assembly of claim 1, wherein the housing comprises a viewing port extending through the housing.

12. A system comprising:
a cutting assembly comprising:
a housing defining a chamber;
a cutting blade;
at least one component; and
a member dividing the chamber into a first chamber and a second chamber; and
a dust removal system comprising a vacuum in fluid communication with the at least one component;
wherein the cutting blade is located in the first chamber and the at least one component is located in the second chamber, and wherein the cutting blade is configured to generate dust as a result of cutting an object comprising a window blind or shade.

13. The system of claim 12, wherein the member comprises:
a first aperture extending from a first side of the member to a second side of the member,
wherein the first aperture defines a first fluid pathway placing the first chamber in fluid communication with the second chamber.

14. The system of claim 13, wherein the member further comprises:
a brush located at the first aperture,
wherein the brush is configured to prevent dust located in the first chamber from entering the second chamber through the first aperture; and
at least one gasket,
wherein the at least one gasket is configured to seal an opening located between the member and at least one other component of the cutting assembly to prevent dust from entering the second chamber from the first chamber through the opening.

15. The system of claim 12, wherein the housing comprises:
a base member;
a first housing member attached to the base member; and
a second housing member attached to the first housing member,
wherein a position of the second housing member is configured to be pivotably displaceable relative the first housing member to allow an operator to access the chamber.

16. The system of claim 12, wherein the at least one component comprises:
a container,
wherein the container accumulates the dust collected from the first chamber.

17. The system of claim 12, wherein the cutting assembly further comprises:
an actuator located in the second chamber,
wherein the actuator defines a second fluid pathway for providing make-up air from an outside of the housing to the second chamber.

18. A device comprising:
a housing defining a chamber;
a cutting blade;
a container; and
a member dividing the chamber into a first chamber and a second chamber, the member comprising a first aperture extending from a first side of the member to a second side of the member, the first aperture defining a first fluid pathway placing the first chamber in fluid communication with the second chamber,
wherein the cutting blade is located in the first chamber, and the cutting blade is configured to generate dust as a result of cutting an object comprising a window blind or shade, and wherein the container is located in the second chamber and the container accumulates the dust collected from the first chamber by a dust removal system comprising a vacuum in fluid communication with the container and the first chamber.

19. The device of claim 18, wherein the member further comprises:
a brush located at the first aperture,
wherein the brush is configured to prevent dust located in the first chamber from entering the second chamber through the first aperture; and
at least one gasket,
wherein the at least one gasket is configured to seal an opening located between the member and at least one other component of the device to prevent the dust from entering the second chamber from the first chamber through the opening.

20. The device of claim 18, further comprising:
an actuator located in the second chamber,
wherein the actuator defines a second fluid pathway for providing make-up air from an outside of the housing to the second chamber.
